(19) United States
(12) Patent Application Publication
(10) Pub. No.: US 2005/0218216 A1
(43) Pub. Date: Oct. 6, 2005

(54) Prepaid card issuing system

(76) Inventor: Luis A. Arias, Miami, FL (US)

Correspondence Address: MALLOY & MALLOY, P.A., 2800 S.W. Third Avenue, Historic Coral Way, Miami, FL, 33129, US

(21) Appl. No.: 11/040,481

(22) Filed: Jan. 21, 2005

Related U.S. Application Data
(63) Continuation of application No. 10/949,029, filed on Sep. 24, 2004.
Application No. 10/949,029 is a continuation-in-part of application No. 10/680,864, filed on Oct. 7, 2003.
(60) Provisional application No. 60/416,735, filed on Oct. 7, 2002.

(51) Int. Cl. G06F 7/08

(52) U.S. Cl. 235/381

(57) ABSTRACT

A prepaid card issuing system that includes a card with identifying indicia associated with a specific entity, such as a store from which products or services can be purchased, and a value such as a financial denomination, disposed thereon. An issuing terminal is also provided and is structured to receive the card, identify the security identifier, and communicate with a remote, control processor that receives the security identifier and defines and communicates to the issuing terminal usage information associated with the security identifier. The issuing terminal is further structured to dispose account information on the card in accordance with said the information so as to permit use of the card for the purchase of products or services, and to retain the card therein during detection of the security identifier, disposition of the account information on the card and printing of an issuance confirmation on the card.

### CLAIM OF PRIORITY

The present application is a Continuation of previously filed, now pending application having Ser. No. 10/949,029 which was filed on Sep. 24, 2004, which is a Continuation-In-Part application of previously filed, now pending application having Ser. No. 10/680,864 which was filed on Oct. 7, 2003, which claims priority under 35 U.S.C. Section 119(e) to provisional patent application pending in the U.S. Patent and Trademark Office having Ser. No. 60/416,735 and a filing date of Oct. 7, 2002, incorporated herein by reference.

### BACKGROUND OF THE INVENTION

1. Field of the Invention

The present invention relates to a prepaid card issuing system which can be utilized to easily and securely issue a prepaid card to a consumer for subsequent use by the consumer in connection with the purchase of products or services. Additionally, the present prepaid card issuing system is an on demand system that permits beneficial promotional display of cards to be issued in a secure manner that minimizes the risk of loss due to theft, both by third parties and by dishonest employees of a merchant that may issue the card, in that a clear indicator is provided to a consumer of valid issuance of the card and the card is issued in a manner which minimizes the possibility of being switched for an un-issued or undervalued card by a dishonest clerk. Further, the present prepaid card issuing system provides for significantly facilitated sales and issuance by a merchant or a consumer in an accurate and effective manner.

2. Description of the Related Art

Prepaid cards such as those utilized for the purchase of a variety of products and services, including those commonly referred to as gift cards or prepaid telephone cards, are becoming an increasingly used medium by which consumers consummate transactions. As can be appreciated, they provide a variety of benefits to the consumer, including the ability to give a gift or a specific monetary value to a third party for use and/or by providing access to specific quantities of goods or services without the need to personally and individually establish a personalized account or credit relationship with the entity offering the products or services to be obtained using the card. Traditionally, prepaid cards have been provided to consumers for use in a limited number of manners. For example, in some situations a stock of issued and active cards are provided to a merchant for resale to consumers, those cards therefore essentially being equated with currency. As can be appreciated, a substantial drawback can be associated with such a card in that they are subject to loss or theft if large quantities are stored by a specific merchant. Furthermore, such prepaid cards necessarily require that the entity that will ultimately be providing the products or services in connection with the prepaid card, hold open and/or maintain an inventory of accounts, sometimes referred to as PIN numbers available for use/redemption.

Another common manner in which prepaid cards are distributed and/or provided to consumers involves a merchant maintaining a stock of non-activated prepaid cards. Specifically, these non-activated prepaid cards typically contain account information thereon associated with the entity in connection with which they will be redeemed, in a specific denomination. These cards, however, are not active and as such, when a consumer purchases the card, a merchant selling the card is charged with actually activating the card. For example, a merchant may scan or swipe a magnetic strip or bar code contained by the card, thereby effectively transmitting account information that is maintained on the card to an activation processor so that during a subsequent transaction when the consumer wishes to utilize the prepaid card, the account number and/or information that had been previously contained on the card is valid and usable.

While such a system of validating prepaid cards may help to reduce the risk of third party theft of the cards, it fails to address all of the drawbacks commonly associated with such prepaid cards. For example, the entity with which the prepaid card will ultimately be utilized must still maintain an account open and/or available in inventory, even if the card will not be used for substantial periods of time. This can be especially burdensome if a very large inventory of cards is needed to be distributed to a number of different merchants. For example, even though such prepaid cards are typically only associated with a specific value of products or services that can be redeemed, the nature of these cards necessarily requires the associated entity to maintain an inventory of outstanding accounts and/or outstanding funds pre-allocated to the expected transaction, so that the cards can be effectively and easily redeemed at any moment by an ultimate consumer. As can be appreciated, such a requirement to maintain an established inventory can prove to be a financial and/or logistical burden to the entity. Moreover, even though theft of a non-validated prepaid card will not permit that card to be utilized, a regrettable problem that has often arisen relates to thefts by employees and/or clerks charged with validating the cards for use, such as at a check out counter. Specifically, it is an all too common occurrence for a consumer to request a card for purchase only to have the vending personnel provide the consumer with a prepaid card which they claim has been validated, but which has actually not been validated. That consumer will unfortunately not find out that the card is invalid until they or its recipient ultimately go to utilize the card for the purchase of products or services. Of course, this is typically at a later date and/or different location when it is difficult to know whether it is a malfunction and/or wherein the consumer may be called into question as having already used the card. In the meantime, the person fraudulently issuing the invalidated card can then use the funds paid by a legitimate consumer to validate a different card, keeping that validated card for their own improper use. Also, because such transactions typically go undetected until some period of time later, it is generally difficult, if not impossible to track back to the fraudulent validation, either before the funds have been spent in the fraudulently validated card and/or in a conclusive manner that cannot be easily attributed to technical malfunctions.

Still another technique that has become more recently used for the issuance of pre-paid cards includes the use of a standard pin delivery system that may print an account number on a receipt or paper card. Such systems often do not conform to the standards required by a variety of entities such as department stores, etc. that use more advanced scanning systems. Furthermore, they are often susceptible to operator error, as they rely on an operator to select a correct card and input correct information, and can be the subject of fraud if an operator causes a lesser value to be issued on a card depicting a greater value on its face.

As a result, it would be beneficial to provide a prepaid card issuing system that can issue a specific prepaid card on demand, thereby eliminating the need for an inventory of specific value accounts to be maintained for an extended period of time, and which achieves effective issuance of a prepaid card in a manner that can effectively confirm to the consumer that a usable card has actually been issued to them, while also minimizing the possibility for theft and/or improper conduct by a merchant or issuing person. Additionally, it would be preferable for such a prepaid card issuing system to be able to work in conjunction with a card that can be effectively displayed to consumers so as to maximize promotional ability to potential consumers, letting them know that a specific card is available for purchase at a specific location. Also, it would be helpful for such a card to independently be able to identify an associated value and/or use therefore so as to minimize operator error in issuing the card and so as to prevent overvaluing or undervaluing a denomination of issuance.

### SUMMARY OF THE INVENTION

The present invention relates to a prepaid card issuing system structured to effectively provide a mechanism by which merchants can sell prepaid cards to consumers in a highly marketable and secure manner. In particular, the prepaid card issuing system includes a card, the card containing some identifying indicia thereon associated with the specific entity and possibly a value. For example, it may be preferred that the identifying indicia include a printed face of a card which provides for the name of a particular store/service provider in connection with which the prepaid card may be ultimately utilized to purchase products or services, as well as including a clear indicator of the value, such as a dollar denomination, of the card.

In addition to the card, the present system includes an issuing terminal. The issuing terminal, which is preferably located at a merchant, but can be located at any locale, is structured to receive the card and to communicate with a remote, control processor. Preferably, the issuing terminal is structured to identify a security identifier that is disposed on the card, and to communicate that security identifier to the remote, control processor, such that the remote, control processor is able to readily and precisely identify the card that is to be issued at the issuing terminal. In response to receipt of the security identifier, the remote control processor is structured to identify and thereafter communicate usage information that is associated with the security identifier to the issuing terminal.

The issuing terminal is further structured to dispose account information on the card in accordance with the usage information provided by the remote control processor, thereby enabling use of the card for the purchase of products or services. Therefore, in a preferred embodiment, a previously unusable card that contained no or incomplete usage information can be issued on demand in a secure and accurate manner without improper intervention.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is an illustration of a first preferred embodiment of the prepaid card issuing system of the present invention;

FIG. 2 is an illustration of one embodiment of a card associated with the prepaid card issuing system of the present invention;

FIG. 3 is an illustration of another embodiment of a card associated with the prepaid card issuing system of the present invention;

FIG. 4 is an illustration of a further embodiment of a card associated with the prepaid card issuing system of the present invention;

FIG. 5 is an illustration of a further embodiment of the pre-paid card issuing system; and

FIG. 6 is an illustration of a further pre-paid card associated with the pre-paid card issuing system of the present invention.

Like reference numerals refer to like parts throughout the several views of the drawings.

### DETAILED DESCRIPTION OF THE PREFERRED EMBODIMENT

Shown throughout the figures, the present invention is directed towards a prepaid card issuing system, generally indicated as 10. In particular, the prepaid card issuing system 10 is preferably configured for utilization by a merchant wishing to profit from the sale of prepaid cards, either for their own products or services or in connection with the products and services of other related or unrelated entities. Of course, it is noted that the prepaid card issuing system of the present invention can be directly operated by a consumer in a private setting or in a more automated environment such as a kiosk, the structure and functionality of the present invention, as will be subsequently described, providing sufficient security to allow handling and manipulation of un-issued cards by any of a variety of individuals without risk of inappropriate issuance.

Along these lines, the prepaid card issuing system 10 of the present invention preferably includes a card 30. The card 30 can take on any of a variety of configurations and can be formed of a stiff or flexible, thin or thick material, as may be desired, and can take on any number of shapes. Nevertheless, in preferred illustrated embodiments of the present invention, the card will preferably include a generally stiff credit card type configuration, so as to provide a degree of durability and storability for an ultimate consumer who will be utilizing the card 30 to purchase products or services. Disposed on the card 30, as illustrated in FIG. 2, is preferably some identifying indicia 36. The identifying indicia 36 may be associated with a specific entity, such as a name or logo, and may also include information as to a value of the card. As previously mentioned, the specific entity may include the merchant selling the card 30 and/or may include any other merchant or company or individual who wishes to offer products and/or services in connection with the use of the card 30. For example, a banking or credit institution may want to provide pre-paid funds for use at any store, or a specific store may want to provide pre-paid funds for use at its store. Further, in the illustrated embodiments the card 30 is two sided, and as such, it may be preferred that the identifying indicia 36 be disposed on one face of the card 30. Of course, it is recognized that the identifying indicia 36 may appear on one or both faces of the card 30, as may be appropriate to suit the desires of the specific entity associated with its use. Moreover, as mentioned, it may also be preferable that the identifying indicia disposed on the card 30 also include a specific value of the card. For example, it is most common that the value include a specific dollar amount, although it is recognized that other values, such as minutes, credits, etc. could also be provided so as to denote a specific value of the card. One principle benefit of the pre-inclusion of the identifying indicia 36 on the card 30 is the ability to effectively hang, display and/or identify a card. This may be especially helpful if a merchant is selling cards 30 that are associated with an entity other than themselves, as it will help consumers to readily recognize that the cards 30 associated with the specific entity are available for purchase at that merchants location. Additionally, however, with the advent of modern color and/or black and white printing technology, the identifying indicia 36 need not be pre-printed on the card, and rather a completely blank card and/or card with other information and/or partial information may be provided, the identifying indicia 36 being printed or otherwise applied to the card 30 before, during or after issuance of the card 30.

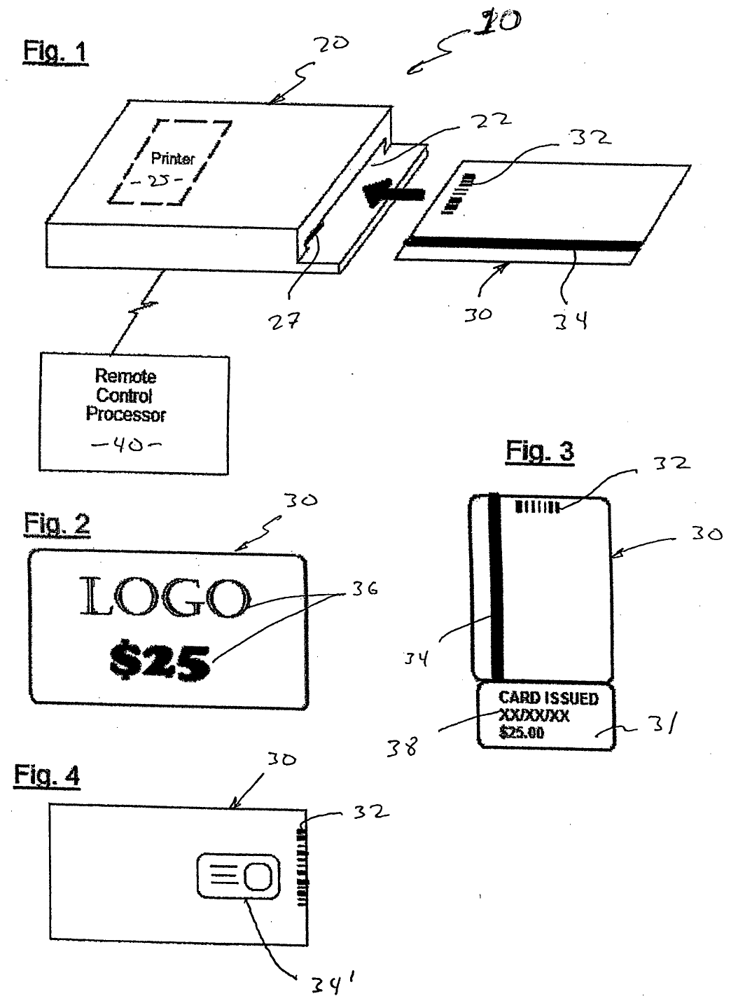

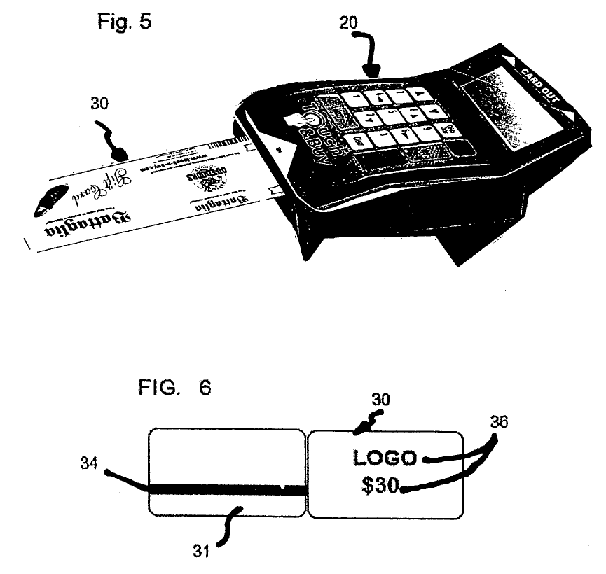

Also included in the prepaid card issuing system 10 of the present invention is an issuing terminal 20. The issuing terminal may take on any of a variety of configurations including a POS terminal, automated kiosk, independent card receiving terminal, home terminal, etc. Preferably, however, the issuing terminal 20 is to be configured to receive the card 30 partially and/or completely therein so as to facilitate and/or permit issuance of the card. Looking further to the issuing terminal 20, it is preferably communicatively associated with a remote control processor 40. The issuing terminal, however, may also be associated with a locally maintained processor which will ultimately communicate with a remote control processor 40 or can help with financial portions of the transaction, and/or the issuing terminal may itself include processing capabilities so as to effectuate financial portions of the transaction. For example, it is understood that in the preferred embodiments of the present invention, a card 30 will be issued in response to a financial transaction whereby a consumer who is to receive the card pays a specified amount, either to a specific merchant having control over the issuing terminal and the cards and planning on issuing the card to the consumer, and/or to a processing facility that upon payment verification will subsequently allow automated or self-issuance of the card by the consumer when a credit card, debit card or cash payment is identified as having been made. Moreover, it is recognized that in most circumstances, the ultimate value of the card 30 will preferably be associated with the financial aspect of a transaction that is related to the purchase of the card. For example, a $25 payment may typically result in the issuance of a $25 card. Of course, a payment that is ultimately made may include only portions associated with the value of the card, and/or based on promotions or other circumstances, the ultimate value of the card may differ from the actual amount paid, it being recognized that as a preferred embodiment some form of payment will be made and effectively verified in order for issuance of the card to be consummated by the prepaid card issuing system 10 of the present invention. Moreover, as seen in FIGS. 1 and 5, respectively, the issuing terminal 20 may be configured to merely process the card 30 as described herein, with no user inputs or external user input facilities being included, or may have a POS type configuration which allows for direct user input, such as in connection with the entry of an employee security or other code or other information during use.

Looking further to the card 30, it preferably includes a security identifier 32 disposed on the card. The security identifier 32 can take on any of a variety of forms which can effectively denote the nature and type of card. For example, conventional text may be utilized as the security identifier 32. Preferably, however, in the preferred embodiments the security identifier 32 is disposed on the card in a machine readable form, and the issuing terminal 20 includes a corresponding reader to effectively read and identify the security identifier 32. As such, in the illustrated embodiments the security identifier 32 includes a bar code, the bar code structured to be read by a corresponding bar code reader of the issuing terminal 20 such that upon preferable inserted introduction of the card 30 into a corresponding slot 22 of the issuing terminal 20, the issuing terminal 20 is able to identify the card 30. Although it recognized that a security identifier could be human readable so as to permit for an individual to manually enter the information into the issuing terminal, and/or the corresponding reader may be separate but communicatively associated with the issuing terminal 20, it is preferred that the issuing terminal 20 itself read and identify the security identifier 32 so as to maximize the security associated with issuance of a card 30. In particular, such a configuration assures that an individual seeking and/or facilitating issuance of a card 30 does not make a mistake and/or unscrupulously provide for issuance of a card in a manner that is not appropriate and/or does not correspond to the card 30. For example, in a case where an employee of a merchant will be providing for the issuance of the card 30 to a consumer, that employee is not able to themselves provide a security identifier and/or otherwise identify a lesser value of the card 30 such that the customer receives a card with diminished value than what was paid for and which the identifying indicia 36 represents, maintaining the security identifier associate with the actual value of the card for subsequent improper issuance of another card.

Additionally, the security identifier 32 functions in some preferred instances as a trigger to the beginning of the issuance process. Specifically, as previously indicated, the issuing terminal 20 is preferably communicatively associated with the remote, control processor 40. The remote control processor 40 is structured to effectuate ultimate issuance of the card 30, preferably via the issuing terminal 20. In this regard, in the preferred, illustrated embodiment the issuing terminal 20 upon detecting the security identifier 32, will communicate the security identifier to the remote control processor 40, the remote control processor 40 thereafter identifying or generating corresponding usage information, and communicating the usage information associated with that security identifier to the issuing terminal 20 for subsequent appropriate issuance of a card 30. In this regard, the preferred embodiment of the remote control processor 40 is preferably structured to validate that the security identifier is accurate and correct, and in many instances is also structured to ensure that appropriate payments have been made. Also, the remote control processor 40 can effectively ensure that a credit line associated with a specific merchant, in an embodiment wherein a merchant will be issuing the cards, is not exceeded by that merchant selling a very large number of cards. In any such instance, the remote control processor 40, whether it be one computer, a plurality of computers/servers/processors, etc., will preferably generate account information, such as in the form of a PIN number to correspond to the manner and value of use of the card 30 to be issued. In this regard, the remote control processor 40 preferably communicates usage information which in many instances will be the account information itself to the issuing terminal, where after the issuing terminal 20 disposes the account information on the card 30 so as to permit subsequent use of the card for the purchase of products or services at a location that can read and validate the account information from the card 30. In this regard, it is noted that even though the account information is preferably included as part of the usage information that is transmitted from the remote control processor 40 to the issuing terminal 20, it does not always need to be. For example, it is understood that a primary benefit of the present invention is the ability to avoid having to maintain an inventory of PIN numbers and/or accounts on a local terminal so as to prevent their use in subsequent and/or different locations. Merely by maintaining an unaffiliated number range that can be later associated with a specific account number, no dedicated and associated inventory need to be maintained at the issuing terminal 20 and in essence account information on demand is provided by the remote control processor 40.

As previously mentioned, issuing terminal 20 is preferably structured to dispose account information on the card 30 so as to permit the card 30 to be subsequently utilized for the purchase of products and/or services, such as in the form of a prepaid telephony card and/or a gift card for use at any of a variety of entities. Although it is recognized that the account information may be disposed on the card 30 in a printed format, in the preferred embodiments of the present invention, the account information will preferably be disposed on the card 30 in a machine readable format, such as by encoding a magnetic strip 34 and/or memory chip 34′ and/or any other means whereby the information is physically and/or virtually imprinted on the card 30. In this regard, the issuing terminal 20 may include a magnetic strip encoder 27 such that when the card 30 is inserted into a corresponding slot 22 of the issuing terminal 20, the issuing terminal 20 may effectively read the security identifier 32 and upon valid receipt of usage information, such as in the form of the account information, it will effectively dispose the account information on the memory strip 34 using the memory strip encoder 27. Further, the issuing terminal 20 is preferably structured to maintain the card 30 at least partially therein from the point that the security identifier 32 is read and the account information is imprinted on the card 30, thereby preventing exchanging of the card 30 in a manner that results in the account information being imprinted on an incorrect or improper card 30.

Looking further to the issuing terminal 20 in order to achieve secure issuance of the card 30, the issuing terminal 20 is preferably structured to receive the card 30 into the corresponding slot 22. Additionally, however, when issuance is completed, it may be configured to return the card out of the same slot 22, and/or as may also be preferred, to receive the card 30 through a slot 22 and thereafter subsequently have the card emerge from an oppositely disposed opening in the issuing terminal 20. Such a configuration may be preferred as it provides for more continuous movement of the card 30 through the issuing terminal 20, and for more effective interaction between the magnetic strip encoder 27 and the magnetic strip 34 in an embodiment which uses the magnetic strip.

As an added security measure that allows customers to be certain a card is correctly issued, the card 30 also preferably includes a receipt portion 31. The receipt portion 31 may be structured to be removable and/or detachable from a remaining portion of the card 30. In this regard, the receipt portion 31 can merely be a designated area of the card 30 which allows printing or which can be torn, cut or otherwise separated without impacting the ability of the card 30 to be subsequently used for the purchase of products of services utilizing the account information disposed thereon. Alternatively, the receipt portion 31 may be separately generated and/or distinctly demarcated on a second portion of said card attached to the remaining part/portion of the card 30, those portions being foldable into confronting relation with one another, as in FIG. 6, so as to impart a degree of thickness and durability to the card, which may facilitate storage and subsequent swiping of the card through an appropriate reader, such as a magnetic stripe reader, while still permitting the use of a thinner card stock to reduce expense and/or facilitate printing. Regardless of its orientation, the receipt portion 31 includes an issuance confirmation 38 disposed thereon, preferably in a printed format. For example, it is preferred that the issuing terminal 20 also include a printer 25. In such an embodiment, the printer 25 is structured to print the issuance confirmation 38 on the card in a manner which will visibly identify to the ultimate consumer that the card has appropriately been issued in an accurate and correct amount. For example, in some embodiments the issuance confirmation 38 may include a statement that the card has been issued, date information, value information, information relative to the entity with which the card may be utilized for the purchase of products or services, etc. As a result, an unscrupulous employee of a merchant who may be assisting with the issuance of a card 30 cannot feign issuance of the card 30, thereafter handing a customer an unissued card which the consumer will not subsequently identify as being non-issued until a later point when they seek to utilize the card for the purchase of products or services, either from the issuing merchant and any other entity correspondingly associated with the usage of the card 30, and in the case of self issuance, will ensure that a malfunction did not occur.

As still another beneficial security feature, the issuing terminal 20 is also preferably structured to receive and maintain the card 30 therein, at least during detection of the security identifier and imprinting of the account information on the card, thereby preventing switching of the card 30 between stages. Additionally, however, the issuing terminal 20 will also receive and maintain the card 30 therein while the issuance confirmation 38 is being printed on the card. In that way, security and accuracy can be ensured for the consumer. Of course, it is understood that the card 30 may be passing into one or more regions of the issuing terminal 20, while still being sufficiently maintained therein to prevent the card from being switched during different stages.

As indicated, the account information may include a PIN number that is associated with a specific value. In this regard, the PIN number is provided in such a manner that a specific entity associated with the ultimate use of the card is able to effectively identify the validity thereof and identify the specific value and/or remaining value in the case of partial usage of an original value on the card and/or a current value in the case of a rechargeable card, thereby correspondingly remitting a quantity of products or services that may be purchased with the card to that value.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A prepaid card issuing system comprising:
a) a card, said card including identifying indicia thereon associated with a specific entity;
b) an issuing terminal, said issuing terminal structured to receive and activate said card; and
c) a printer, said printer structured to print an issuance confirmation on said card so as to provide a visual verification that said card has been activated.

2. A prepaid card issuing system as recited in claim 1 wherein said issuing terminal includes said printer.

3. A prepaid card issuing system as recited in claim 1 wherein said issuing terminal is structured to at least partially receive said card and maintain said card therein while printing said issuance confirmation on said card and activating said card so as to ensure that said issuance confirmation is printed on said card that is activated.

4. A prepaid card issuing system as recited in claim 1 wherein said identifying indicia further includes a value of said card when activated.

5. A prepaid card issuing system as recited in claim 1 wherein said card includes a receipt portion on which said issuance confirmation is printed.

6. A prepaid card issuing system as recited in claim 5 wherein said receipt portion is a designated area of said card.

7. A prepaid card issuing system as recited in claim 5 wherein said card includes two portions, one of said portions including said receipt portion, and said two portions being foldable into confronting relation with one another so as to impart an increased thickness to said card.
